(19) United States
(12) Patent Application Publication
(10) Pub. No.: US 2015/0251499 A1
(43) Pub. Date: Sep. 10, 2015

(54) TIRE TREAD FEATURING A SIPE

(71) Applicant: Bridgestone Americas Tire Operations, LLC, Nashville, TN (US)

(72) Inventors: Jie Jin, Copley, OH (US); Cory Williams, Medina, OH (US); Joseph Woodward, Akron, OH (US)

(21) Appl. No.: 14/618,611

(22) Filed: Feb. 10, 2015

Related U.S. Application Data
(60) Provisional application No. 61/949,309, filed on Mar. 7, 2014.

(51) Int. Cl. B60C 11/12; B60C 11/13

(52) U.S. Cl. CPC B60C 11/1204; B60C 11/1307

(57) ABSTRACT

Various embodiments of a tire tread having at least one sipe comprising an S-shaped geometry are disclosed.

### BACKGROUND

Tires, including Off-Road Radial (“ORR”) tires, may comprise tread featuring sipes. The presence of sipes in a tire tread may create more surface edges to engage a roadway, which may increase traction in adverse road conditions. For example, a tire tread including sipes may perform better in icy road conditions than a tire tread not including sipes.

However, the addition of sipes to a tire tread block may reduce block stiffness, which may result in undesirable irregular wear patterns in the tire. Additionally, a tire tread featuring sipes may undesirably capture stones in the sipes. Stones caught in a tire tread's sipes may reduce the effectiveness of the tire tread in increasing traction, may damage the tire or tire tread, may cause irregular wear patterns in the tire, and may create a safety hazard if the stones are ejected as the tire travels down a roadway.

What is needed is a tire tread block featuring sipes configured to reduce irregular wear and capturing of stones.

### SUMMARY

In one embodiment a tire is provided, the tire comprising: a tread portion comprising at least one of a tread block and a tread rib; at least one of the tread block and the tread rib having at least one sipe, wherein the at least one sipe includes at least one convex portion and at least one concave portion forming an S-shaped geometry in a ground-contacting surface, wherein the at least one sipe includes an upper vertical section and a lower vertical section oriented substantially radially within the sipe, wherein the at least one sipe includes a first curvilinear portion and a second curvilinear portion oriented substantially radially within the sipe, and forming an S-shaped geometry having an amplitude, and wherein the at least one sipe has a height.

In another embodiment a tire is provided, the tire comprising: a tread portion comprising at least one of a tread block and a tread rib; at least one of the tread block and the tread rib having at least one sipe, wherein the at least one sipe includes at least one convex portion and at least one concave portion forming an S-shaped geometry in a ground-contacting surface, wherein the at least one sipe includes an upper vertical section and a lower vertical section oriented substantially radially within the sipe, wherein the at least one sipe includes a first curvilinear portion and a second curvilinear portion oriented substantially radially within the sipe, and forming an S-shaped geometry having an amplitude, and wherein the amplitude varies along a height of the sipe.

In one embodiment, a tire sipe blade is provided, the tire sipe blade comprising: at least one convex portion and at least one concave portion forming an S-shaped geometry; at least one upper vertical section and at least one lower vertical section substantially parallel to one another; a first curvilinear portion and a second curvilinear portion forming an S-shaped geometry having an amplitude; and wherein the tire sipe blade has a height.

### BRIEF DESCRIPTION OF THE DRAWINGS

The accompanying figures, which are incorporated in and constitute a part of the specification, illustrate various example configurations, and are used merely to illustrate various example embodiments. In the figures, like elements bear like reference numerals.

FIG. 1 illustrates a top elevational view of an example embodiment of a tire tread having a sipe featuring an S-shaped geometry.

FIG. 2 illustrates a side elevational view of an example embodiment of a tire tread having a sipe featuring an S-shaped geometry.

FIG. 3 illustrates a plan view of an example embodiment of a tire tread having a sipe featuring an S-shaped geometry.

FIG. 4 illustrates a perspective view of an example embodiment of a tire tread having a sipe featuring an S-shaped geometry.

FIG. 5 illustrates a plan view of an example embodiment of a tire tread having a sipe featuring an S-shaped geometry.

FIG. 6A illustrates a perspective view of an example embodiment of a tire sipe blade for forming a sipe featuring an S-shaped geometry.

FIG. 6B illustrates a side elevational view of an example embodiment of a tire sipe blade for forming a sipe featuring an S-shaped geometry.

FIG. 6C illustrates a top elevational view of an example embodiment of a tire sipe blade for forming a sipe featuring an S-shaped geometry.

FIG. 7 illustrates a plan view of an example embodiment of a tire tread having a sipe featuring a variable S-shaped geometry.

FIG. 8 illustrates a perspective view of an example embodiment of a tire tread having a sipe featuring a variable S-shaped geometry.

FIG. 9 illustrates a plan view of an example embodiment of a tire tread having a sipe featuring a variable S-shaped geometry.

FIG. 10A illustrates a perspective view of an example embodiment of a tire sipe blade for forming a sipe featuring a variable S-shaped geometry.

FIG. 10B illustrates a side elevational view of an example embodiment of a tire sipe blade for forming a sipe featuring a variable S-shaped geometry.

FIG. 10C illustrates a top elevational view of an example embodiment of a tire sipe blade for forming a sipe featuring a variable S-shaped geometry.

### DETAILED DESCRIPTION

Tires not intended for operation on smooth, dry surfaces typically comprise a tread pattern, including a least one groove, at least one rib, and/or a plurality of tread blocks. Tires intended for operation in inclement conditions, including for example icy or snowy conditions, may additionally comprise a plurality of sipes in the tire tread. The addition of sipes in the tire tread may result in more surface edges in the tire tread for engagement with the icy or snowy roadway.

If one or more tire is mounted on a vehicle, the entire weight of the vehicle, and the one or more tire, is supported by the contact patch of the one or more tire. A tire's contact patch is that portion of the tire in contact with a roadway or other surface supporting the vehicle at any given instant in time. Many tires, including for example ORR tires, may be used on heavy vehicles and thus may experience great pressures and forces in the contact patch's interface with the roadway.

Stones or other debris encountered between the tire's contact patch and the roadway can be forced into the tire's tread with great force. In a tire tread comprising sipes, stones or other debris may be lodged in the sipe, thus reducing the sipe's effectiveness at increasing traction, causing damage to the tire or tire tread, causing irregular wear, and/or creating a safety hazard should the stone or other debris be ejected during tire operation.

Traditional sipes comprise substantially radially-oriented, narrow slits extending from a tread surface into the tread. These traditional sipes typically include straight, parallel walls, providing a stone or other debris easy access to the void created by the sipe. In some instances, a stone or other debris can become lodged within the sipe in such a manner so as to affect the stiffness of a tread block or rib containing the sipe, resulting in irregular wear or damage to the tire tread.

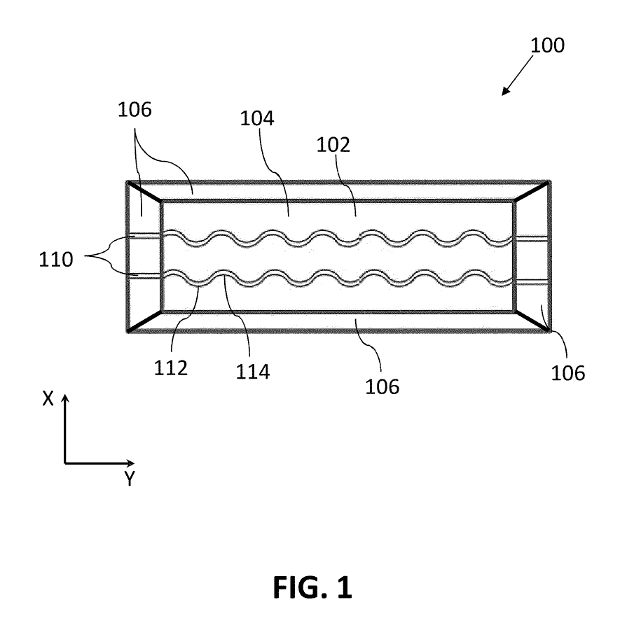

FIG. 1 illustrates a top elevational view of an example embodiment of a tire tread 100. Tread 100 may comprise a tread block 102. Tread block 102 may comprise a ground-contacting surface 104 and at least one side surface 106.

In one embodiment, tread 100 comprises at least one of tread block 102, and a tread rib (not shown). Tread 100 may comprise a combination of tread blocks 102 and at least one tread rib (not shown). At least one tread rib (not shown) may be oriented substantially circumferentially about tire tread 100 (i.e., substantially parallel to the X-axis).

In one embodiment, tread block 102 is oriented such that it comprises a longer dimension (L1/L2) oriented in an axial direction (i.e., substantially parallel to Y-axis). Tread block 102 may be oriented such that it comprises a longer dimension (L1/L2) oriented in a circumferential direction (i.e., substantially parallel to X-axis). Tread block 102 may be oriented at an angle relative to the axial direction or the circumferential direction.

Tread block 102 may comprise at least one sipe 110. At least one sipe 110 may be oriented substantially axially (i.e., substantially parallel to the Y-axis), substantially circumferentially (i.e., substantially parallel to the X-axis), and/or inclined at an angle relative to either the X-axis or the Y-axis. At least one sipe 110 may include a plurality of sipes oriented substantially parallel to one another. At least one sipe 110 may include a plurality of sipes inclined at an angle relative to one another.

At least one sipe 110 may comprise an S-shaped geometry. In one embodiment, sipe 100 may comprise a plurality of alternating convex portions 112 and concave portions 114 (relative to at least one side surface 106). Convex portions 112 and concave portions 114 may be oriented as illustrated in FIG. 1 so as to form a continuous S-shaped geometry along at least a portion of the length of sipe 110.

The S-shaped geometry of sipe 110 may extend all the way to at least one side surface 106. Sipe 110 may intersect at least one side surface 106 with a substantially straight geometry portion (not shown), which intersects at least one of convex portion 112 and concave portion 114, such that the S-shaped geometry does not extend to side surface 106. In one embodiment, sipe 110 may not extend to any side surface 106, such that sipe 110 is contained within an interior portion of ground-contacting surface 104.

In one embodiment, sipe 110 may comprise a S-shaped geometry similar to a sinusoidal curve. The amplitude of the curve in sipe 110 may be constant along the length of sipe 110. The amplitude of the curve in sipe 110 may alternatively vary along the length of sipe 110. In one embodiment, the wavelength of the curve in sipe 110 may be constant along the length of sipe 110. The wavelength of the curve in sipe 110 may alternatively vary along the length of sipe 110. In one embodiment, a plurality of sipes 110 may be contained within tread block 102 or tread rib (not shown), and the curves of sipes 110 may be in phase with one another. Alternatively, the curves of sipes 110 may be out of phase with one another.

Tread block 102 may comprise a length and a width. Tread block 102 may comprise a tapered orientation, such that ground-contacting surface 104 has a smaller area than a base of tread block 102. Tread block 102 may comprise any of a variety of cross-sections, including a substantially rectangular cross-section, a substantially square cross-section, a substantially triangular cross-section, a substantially trapezoidal cross-section, or a cross-section substantially similar to any regular or irregular shape.

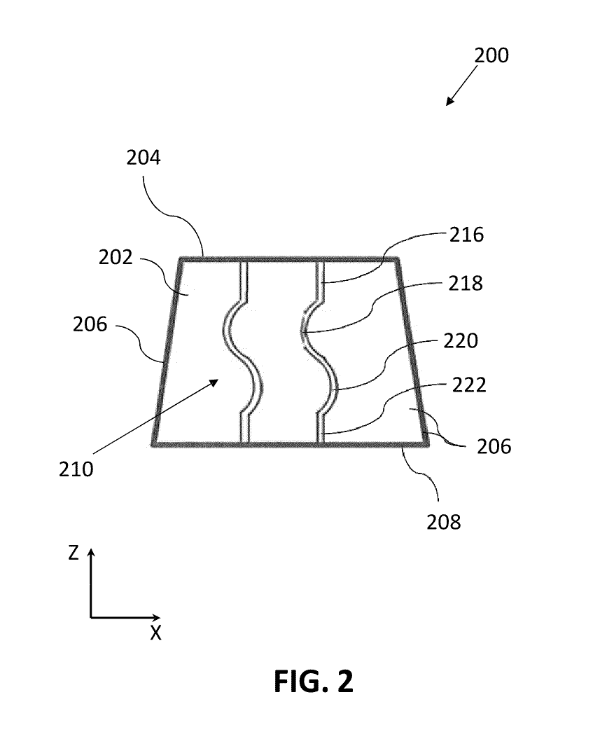

FIG. 2 illustrates a side elevational view of an example embodiment of a tire tread 200. Tread 200 may comprise a tread block 202. Tread block 202 may comprise a ground-contacting surface 204, at least one side surface 206, and a base 208.

In one embodiment, tread 200 comprises at least one of tread block 202, and a tread rib (not shown).

Tread block 202 may comprise at least one sipe 210. At least one sipe 210 may open to at least one side surface 206. In one embodiment, at least one sipe 210 may not open to any side surface 206.

At least one sipe 210 may comprise an upper vertical section 216 in communication with ground-contacting surface 204. Upper vertical section 216 may comprise a sipe section substantially parallel to the Z-axis. In one embodiment, upper vertical section 216 may be inclined relative to the Z-axis. In one embodiment, upper vertical section 216 is substantially coplanar with a YZ-plane. In one embodiment, upper vertical section 216 is inclined at an angle relative to a YZ-plane.

At least one sipe 210 may comprise a first curvilinear portion 218. At least one sipe 210 may comprise a second curvilinear portion 220. First curvilinear portion 218 and second curvilinear portion 220 may be oriented so as to form an S-shaped geometry. In one embodiment, at least one sipe 210 comprises additional curvilinear portions (not shown) oriented relative to first curvilinear portion 218 and second curvilinear portion 220 so as to form an extended S-shaped geometry.

In one embodiment, first curvilinear portion 218 may communicate with ground-contacting surface directly. In one embodiment, second curvilinear portion 220 may communicate with base 208 directly. Additional curvilinear portions (not shown) may communicate with ground contacting portion 204, base 208, upper vertical section 216, and/or a lower vertical section 222.

At least one sipe 210 may comprise lower vertical section 222. Lower vertical section 222 may contact base 208. Lower vertical section 222 may comprise a sipe section substantially parallel to the Z-axis. In one embodiment, lower vertical section 222 may be inclined relative to the Z-axis. In one embodiment, lower vertical section 222 is substantially coplanar with a YZ-plane. In one embodiment, lower vertical section 222 is inclined at an angle relative to a YZ-plane. In one embodiment, upper vertical section 216 and lower vertical section 222 are substantially parallel. In another embodiment, upper vertical section 216 and lower vertical section 222 are substantially coplanar.

In one embodiment, first curvilinear portion 218 and second curvilinear portion 220 of sipe 210 may comprise a S-shaped geometry similar to a sinusoidal curve. The amplitude of the curve in sipe 210 may be constant along the height of sipe 210. The amplitude of the curve in sipe 210 may alternatively vary along the height of sipe 210. In one embodiment, the wavelength of the curve in sipe 210 may be constant along the height of sipe 210. The wavelength of the curve in sipe 210 may alternatively vary along the height of sipe 210. In one embodiment, a plurality of sipes 210 may be contained within tread block 202 or tread rib (not shown), and the curves of sipes 210 may be in phase with one another. Alternatively, the curves of sipes 210 may be out of phase with one another.

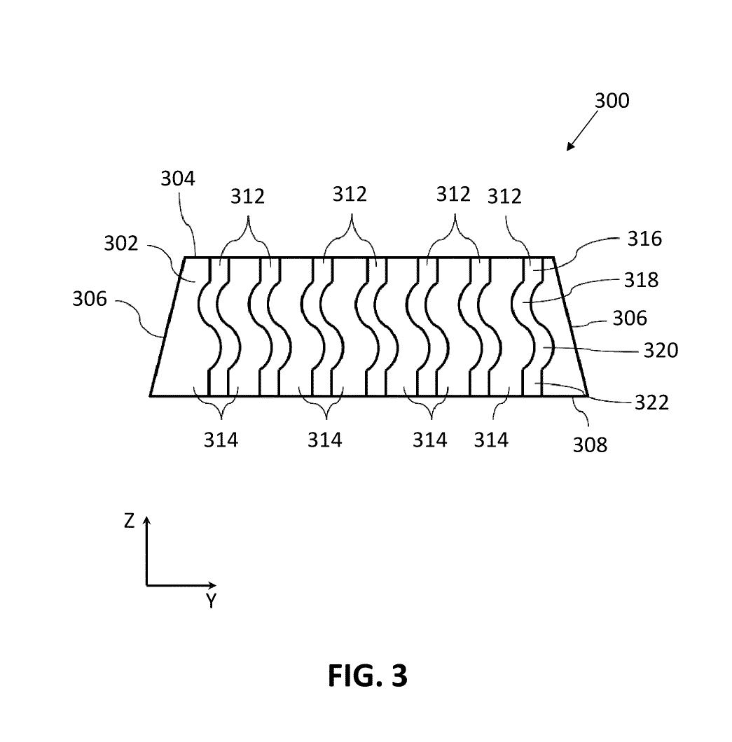

FIG. 3 illustrates a plan view of an example embodiment of a tire tread 300. Tread 300 may comprise a tread block 302. Tread block 302 may comprise a ground-contacting surface 304, at least one side surface 306, and a base 308.

FIG. 3 represents a plan view wherein tread block 302 was separated into two halves at the sipe (not shown), which may substantially correspond to a YZ-plane. The sipe (not shown) may comprise at least one convex portion 312, and at least one concave portion 314. At least one convex portion 312 and at least one concave portion 314 may alternate to result in an S-shaped geometry within the sipe (not shown). In one embodiment, at least one convex portion 312 and at least one concave portion 314 may correspond to at least one convex portion 112 and at least one concave portion 114 illustrated in FIG. 1.

In one embodiment, at least one convex portion 312 comprises a substantially S-shaped geometry in a YZ-plane. At least one convex portion 312 may comprise an upper vertical section 316, a first curvilinear portion 318, a second curvilinear portion 320, and a lower vertical section 322. Upper vertical section 316 may communicate with ground-contacting portion 304. Lower vertical section 322 may contact base 308.

In one embodiment, first curvilinear portion 318 and second curvilinear portion 320 of the sipe (not shown) may comprise a S-shaped geometry similar to a sinusoidal curve. The amplitude of the curve in the sipe (not shown) may be constant along the height of the sipe (not shown). The amplitude of the curve in the sipe (not shown) may alternatively vary along the height of the sipe (not shown). In one embodiment, the wavelength of the curve in the sipe (not shown) may be constant along the height of the sipe (not shown). The wavelength of the curve in the sipe (not shown) may alternatively vary along the height of the sipe (not shown). In one embodiment, a plurality of sipes (not shown) may be contained within tread block 302 or tread rib (not shown), and the curves of the sipes (not shown) may be in phase with one another. Alternatively, the curves of the sipes (not shown) may be out of phase with one another.

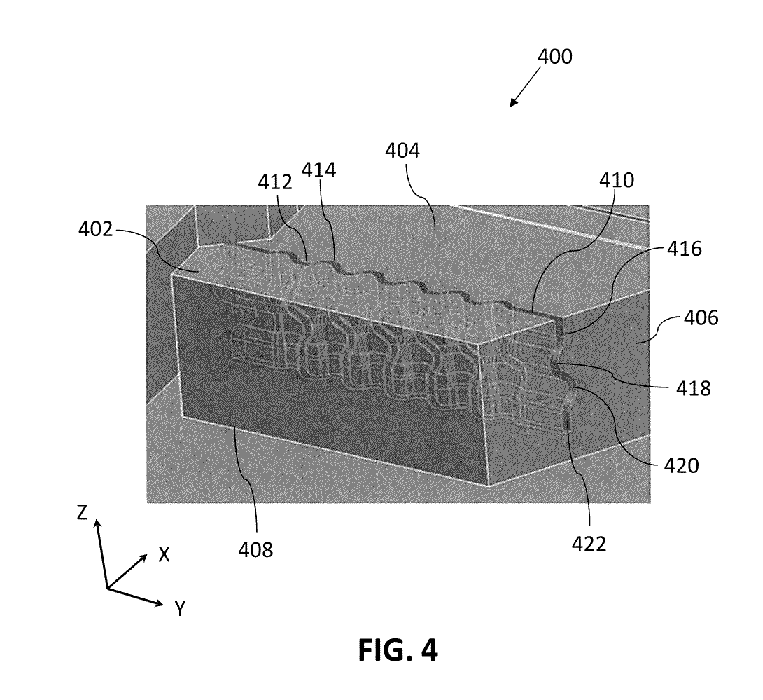

FIG. 4 illustrates a perspective view of an example embodiment of a tire tread 400. Tire tread 400 may comprise a tread block 402. Tread block 402 may comprise a ground-contacting surface 404, at least one side surface 406, and a base 408. Tread block 402, or a tread rib (not shown) may comprise at least one sipe 410. At least one sipe 410 may comprise at least one convex portion 412 and at least one concave portion 414. In one embodiment, sipe 410 comprises alternating convex portions 412 and concave portions 414 forming an S-shaped geometry in a plane substantially parallel to an XY-plane.

At least one sipe 410 may comprise an upper vertical section 416, a first curvilinear portion 418, a second curvilinear portion 420, and a lower vertical section 422. First curvilinear portion 418 and second curvilinear portion 420 may form an S-shaped geometry in a plane substantially parallel to an XZ-plane.

As illustrated in FIG. 4, at least one sipe 410 may comprise an S-shaped geometry in each of an XY-plane, an XZ-plane, and a YZ-plane. In another embodiment, at least one sipe 410 may comprise an S-shaped geometry in at least one of an XY-plane, an XZ-plane, and a YZ-plane. In another embodiment, at least one sipe 410 may comprise an S-shaped geometry in at least two of an XY-plane, an XZ-plane, and a YZ-plane.

In one embodiment, the S-shaped geometry within sipe 410 creates a series of protrusions and indentations configured to engage one another and increase stiffness of tread block 402 or a tread rib (not shown). Increased stiffness of tread block 402 or a tread rib (not shown) may prevent, mitigate, or reduce irregular wearing of tread block 402 or a tread rib (not shown).

In one embodiment, the S-shaped geometry within sipe 410 eliminates the direct path extending radially-inwardly from a ground-contact surface as featured in traditional sipes. The S-shaped geometry may create an indirect path that prevents, or at least reduces the occurrence of, stones or other debris from entering, or lodging, within sipe 410. In this manner, the S-shaped geometry may prevent, or at least reduce the occurrence of, stones or other debris from reducing sipe 410's effectiveness at increasing traction, causing damage to tire tread 400 and/or tread block 402, and/or creating a safety hazard resulting from lodged stones or other debris being ejected during tire operation.

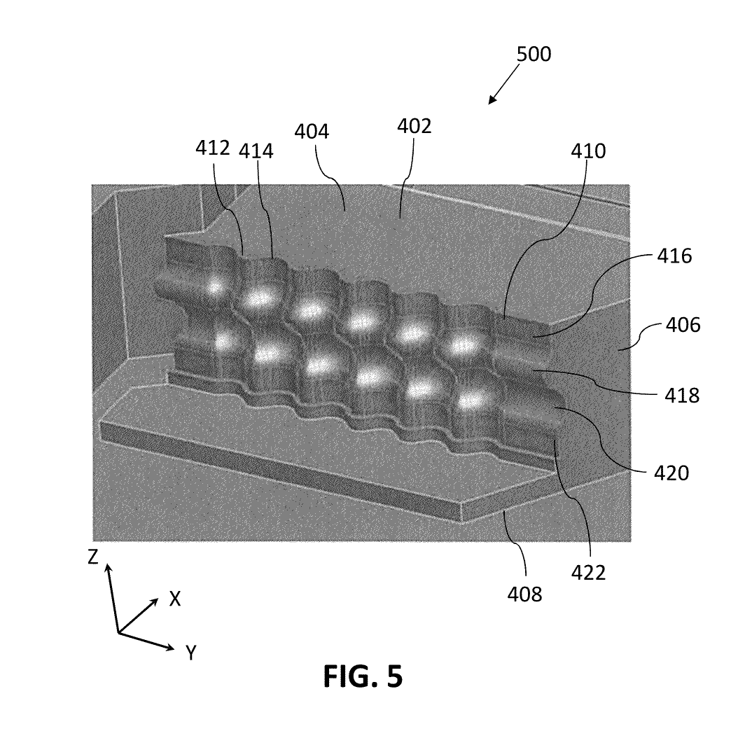

FIG. 5 illustrates a plan view of an example embodiment of a tire tread 500. Tire tread 500 may comprise a tread block 402. Tread block 402 may comprise a ground-contacting surface 404, at least one side surface 406, and a base 408.

FIG. 5 represents a plan view wherein tread block 402 was separated into two halves at the sipe (not shown), which may substantially correspond to a YZ-plane.

Tread block 402, or a tread rib (not shown) may comprise at least one sipe (not shown). At least one sipe (not shown) may comprise at least one convex portion 412 and at least one concave portion 414. In one embodiment, a sipe (not shown) comprises alternating convex portions 412 and concave portions 414 forming an S-shaped geometry in a plane substantially parallel to an XY-plane.

At least one sipe (not shown) may comprise an upper vertical section 416, a first curvilinear portion 418, a second curvilinear portion 420, and a lower vertical section 422. First curvilinear portion 418 and second curvilinear portion 420 may form an S-shaped geometry in a plane substantially parallel to an XZ-plane.

As illustrated in FIG. 5, at least one sipe (not shown) may comprise an S-shaped geometry in each of an XY-plane, an XZ-plane, and a YZ-plane. In another embodiment, at least one sipe (not shown) may comprise an S-shaped geometry in at least one of an XY-plane, an XZ-plane, and a YZ-plane. In another embodiment, at least one sipe (not shown) may comprise an S-shaped geometry in at least two of an XY-plane, an XZ-plane, and a YZ-plane.

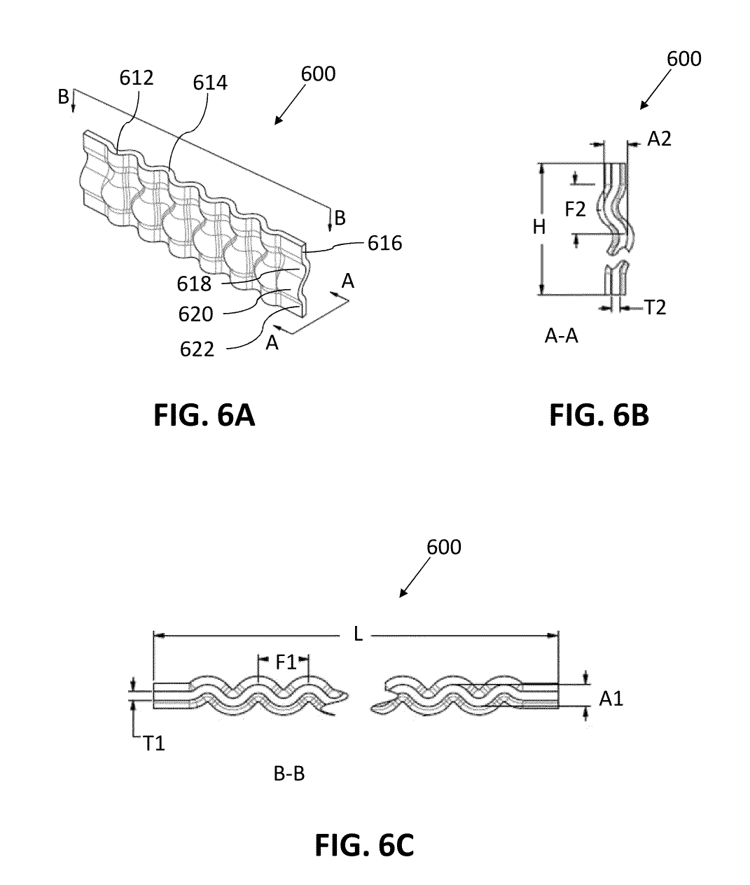

FIG. 6A illustrates a perspective view of an example embodiment of a tire sipe blade 600. Tire sipe blade 600 may be used in forming a sipe featuring an S-shaped geometry. A tire formed using tire sipe blade 600 may have sipe dimensions substantially similar to those described below with respect to tire sipe blade 600.

As illustrated, tire sipe blade 600 may comprise an S-shaped geometry in planes corresponding to each of an XY-plane, an XZ-plane, and a YZ-plane. In another embodiment, tire sipe blade 600 may comprise an S-shaped geometry in at least one of an XY-plane, an XZ-plane, and a YZ-plane. In another embodiment, tire sipe blade 600 may comprise an S-shaped geometry in at least two of an XY-plane, an XZ-plane, and a YZ-plane.

Tire sipe blade 600 may comprise at least one convex portion 612, at least one concave portion 614, an upper vertical section 616, a first curvilinear portion 618, a second curvilinear portion 620, and a lower vertical section 622.

FIG. 6B illustrates a side elevational view of an example embodiment of a tire sipe blade 600 taken about a view A-A.

Tire sipe blade 600 may include S-shaped geometry having an amplitude A2. Amplitude A2 may be any of a variety of values. In one embodiment, amplitude A2 may range between about 0.25 mm and about 20.0 mm. In another embodiment, amplitude A2 may be greater than about 20.0 mm. In another embodiment, amplitude A2 may be less than about 0.25 mm.

Tire sipe blade 600 may include S-shaped geometry having a wavelength F2. Wavelength F2 may be any of a variety of values. In one embodiment, wavelength F2 may range between about 1.00 mm and about 85.0 mm. In another embodiment, wavelength F2 may be greater than about 85.0 mm. In another embodiment, wavelength F2 may be less than about 1.00 mm.

Tire sipe blade 600 may comprise a thickness T2. Thickness T2 may be any of a variety of values. In one embodiment, thickness T2 may range between about 0.25 mm and about 10.0 mm. In another embodiment, thickness T2 may be greater than about 10.0 mm. In another embodiment, thickness T2 may be less than about 0.25 mm.

Tire sipe blade 600 may comprise a height H. Height H may be any of a variety of values. In one embodiment, height H may range between about 3.00 mm and about 275.0 mm. In another embodiment, height H may be greater than about 275.0 mm. In another embodiment, height H may be less than about 3.00 mm.

FIG. 6C illustrates a top elevational view of an example embodiment of a tire sipe blade 600 taken about a view B-B.

Tire sipe blade 600 may include S-shaped geometry having an amplitude A1. Amplitude A1 may be any of a variety of values. In one embodiment, amplitude A1 may range between about 0.25 mm and about 20.0 mm. In another embodiment, amplitude A1 may be greater than about 20.0 mm. In another embodiment, amplitude A1 may be less than about 0.25 mm.

Tire sipe blade 600 may include S-shaped geometry having a wavelength F1. Wavelength F1 may be any of a variety of values. In one embodiment, wavelength F1 may range between about 0.25 mm and about 125.0 mm. In another embodiment, wavelength F1 may be greater than about 125.0 mm. In another embodiment, wavelength F1 may be less than about 0.25 mm.

Tire sipe blade 600 may comprise a thickness T1. Thickness T1 may be any of a variety of values. In one embodiment, thickness T1 may range between about 0.25 mm and about 10.0 mm. In another embodiment, thickness T1 may be greater than about 10.0 mm. In another embodiment, thickness T1 may be less than about 0.25 mm.

Tire sipe blade 600 may comprise a length L. Length L may be any of a variety of values. In one embodiment, length L may range between about 2.00 mm and about 900.0 mm. In another embodiment, length L may be greater than about 900.0 mm. In another embodiment, length L may be less than about 2.00 mm.

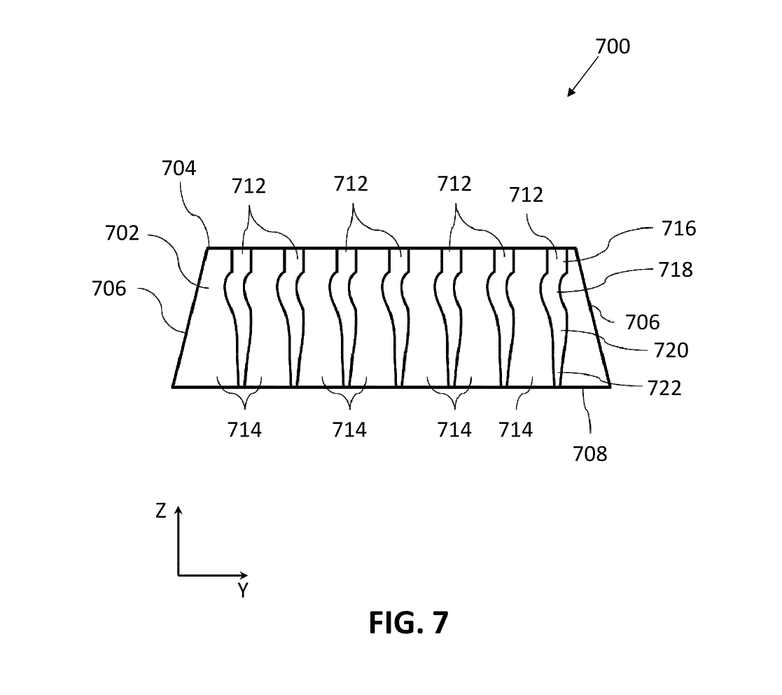

FIG. 7 illustrates a plan view of an example embodiment of a tire tread 700. Tread 700 may comprise a tread block 702. Tread block 702 may comprise a ground-contacting surface 704, at least one side surface 706, and a base 708.

FIG. 7 represents a plan view wherein tread block 702 was separated into two halves at the sipe (not shown), which may substantially correspond to a YZ-plane. The sipe (not shown) may comprise at least one convex portion 712, and at least one concave portion 714. At least one convex portion 712 and at least one concave portion 714 may alternate to result in an S-shaped geometry within the sipe (not shown). In one embodiment, at least one convex portion 712 and at least one concave portion 714 may correspond to at least one convex portion 112 and at least one concave portion 114 illustrated in FIG. 1.

In one embodiment, at least one convex portion 712 comprises a substantially S-shaped geometry in a YZ-plane. At least one convex portion 712 may comprise an upper vertical section 716, a first curvilinear portion 718, a second curvilinear portion 720, and a lower vertical section 722. Upper vertical section 716 may communicate with ground-contacting portion 704. Lower vertical section 722 may contact base 708.

In one embodiment, first curvilinear portion 718 and second curvilinear portion 720 of the sipe (not shown) may comprise a S-shaped geometry similar to a sinusoidal curve. The amplitude of the curve in the sipe (not shown) may be varying along the height of the sipe (not shown). In one embodiment, the amplitude of the curve in the sipe (not shown) may be reduced as the curve extends from the radially outermost portion of the curve (i.e., toward ground-contacting surface 704 of tread block 702) toward the radially innermost portion of the curve (i.e., toward base 708.

In one embodiment, the wavelength of the curve in the sipe (not shown) may be constant along the height of the sipe (not shown). The wavelength of the curve in the sipe (not shown) may alternatively vary along the height of the sipe (not shown). In one embodiment, a plurality of sipes (not shown) may be contained within tread block 702 or tread rib (not shown), and the curves of the sipes (not shown) may be in phase with one another. Alternatively, the curves of the sipes (not shown) may be out of phase with one another.

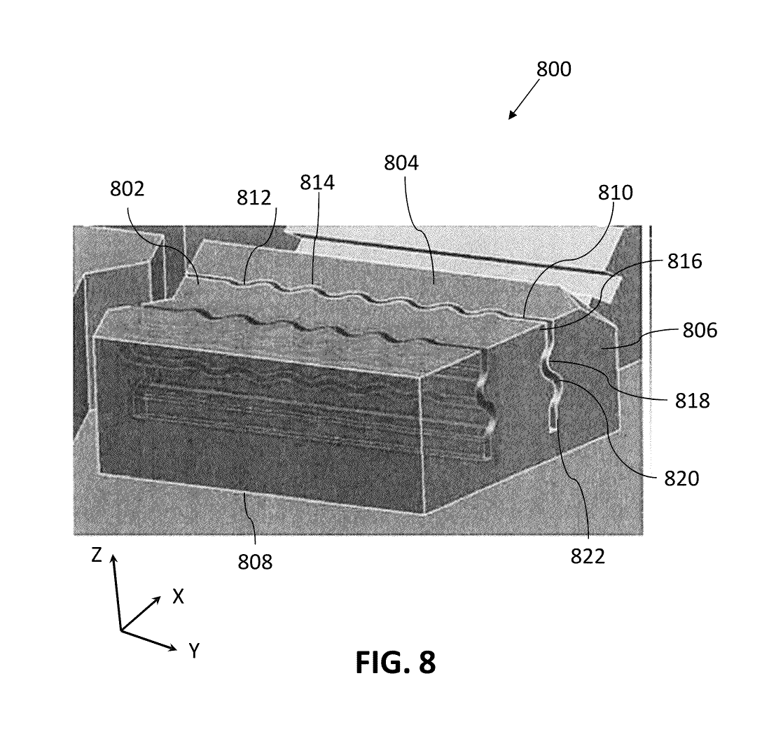

FIG. 8 illustrates a perspective view of an example embodiment of a tire tread 800. Tire tread 800 may comprise a tread block 802. Tread block 802 may comprise a ground-contacting surface 804, at least one side surface 806, and a base 808.

Tread block 802, or a tread rib (not shown), may comprise at least one sipe 810. At least one sipe 810 may comprise at least one convex portion 812 and at least one concave portion 814. In one embodiment, sipe 810 comprises alternating convex portions 812 and concave portions 814 forming an S-shaped geometry in a plane substantially parallel to an XY-plane.

At least one sipe 810 may comprise an upper vertical section 816, a first curvilinear portion 818, a second curvilinear portion 820, and a lower vertical section 822. First curvilinear portion 818 and second curvilinear portion 820 may form an S-shaped geometry in a plane substantially parallel to an XZ-plane.

As illustrated in FIG. 8, at least one sipe 810 may comprise an S-shaped geometry in each of an XY-plane, an XZ-plane, and a YZ-plane. In another embodiment, at least one sipe 810 may comprise an S-shaped geometry in at least one of an XY-plane, an XZ-plane, and a YZ-plane. In another embodiment, at least one sipe 810 may comprise an S-shaped geometry in at least two of an XY-plane, an XZ-plane, and a YZ-plane. In one embodiment, at least one sipe 810 may comprise a curve having an amplitude that varies along the height of sipe 810 in a YZ-plane.

In one embodiment, the S-shaped geometry within sipe 810 creates a series of protrusions and indentations configured to engage one another and increase stiffness of tread block 802 or a tread rib (not shown). Increased stiffness of tread block 802 or a tread rib (not shown) may prevent, mitigate, or reduce irregular wearing of tread block 802 or a tread rib (not shown).

In one embodiment, the S-shaped geometry within sipe 810 eliminates the direct path extending radially-inwardly from a ground-contact surface as featured in traditional sipes. The S-shaped geometry may create an indirect path that prevents stones or other debris from entering, or lodging, within sipe 810. In this manner, the S-shaped geometry may prevent stones or other debris from reducing sipe 810's effectiveness at increasing traction, causing damage to tire tread 800 and/or tread block 802, and/or creating a safety hazard resulting from lodged stones or other debris being ejected during tire operation.

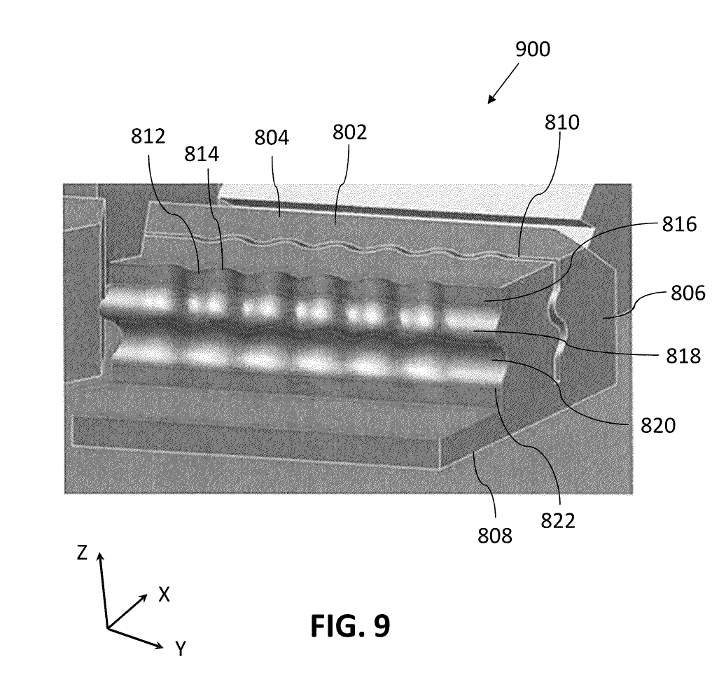

FIG. 9 illustrates a plan view of an example embodiment of a tire tread 900. Tire tread 900 may comprise a tread block 802. Tread block 802 may comprise a ground-contacting surface 804, at least one side surface 806, and a base 808.

FIG. 9 represents a plan view wherein tread block 802 was separated into two halves at the sipe (not shown), which may substantially correspond to a YZ-plane. Tread block 802, or a tread rib (not shown), may comprise at least one sipe (not shown). At least one sipe (not shown) may comprise at least one convex portion 812 and at least one concave portion 814. In one embodiment, a sipe (not shown) comprises alternating convex portions 812 and concave portions 814 forming an S-shaped geometry in a plane substantially parallel to an XY-plane.

At least one sipe (not shown) may comprise an upper vertical section 816, a first curvilinear portion 818, a second curvilinear portion 820, and a lower vertical section 822. First curvilinear portion 818 and second curvilinear portion 820 may form an S-shaped geometry in a plane substantially parallel to an XZ-plane.

As illustrated in FIG. 9, at least one sipe (not shown) may comprise an S-shaped geometry in each of an XY-plane, an XZ-plane, and a YZ-plane. In another embodiment, at least one sipe (not shown) may comprise an S-shaped geometry in at least one of an XY-plane, an XZ-plane, and a YZ-plane. In another embodiment, at least one sipe (not shown) may comprise an S-shaped geometry in at least two of an XY-plane, an XZ-plane, and a YZ-plane. In one embodiment, at least one sipe (not shown) may comprise a curve having an amplitude that varies along the height of the sipe (not shown) in a YZ-plane.

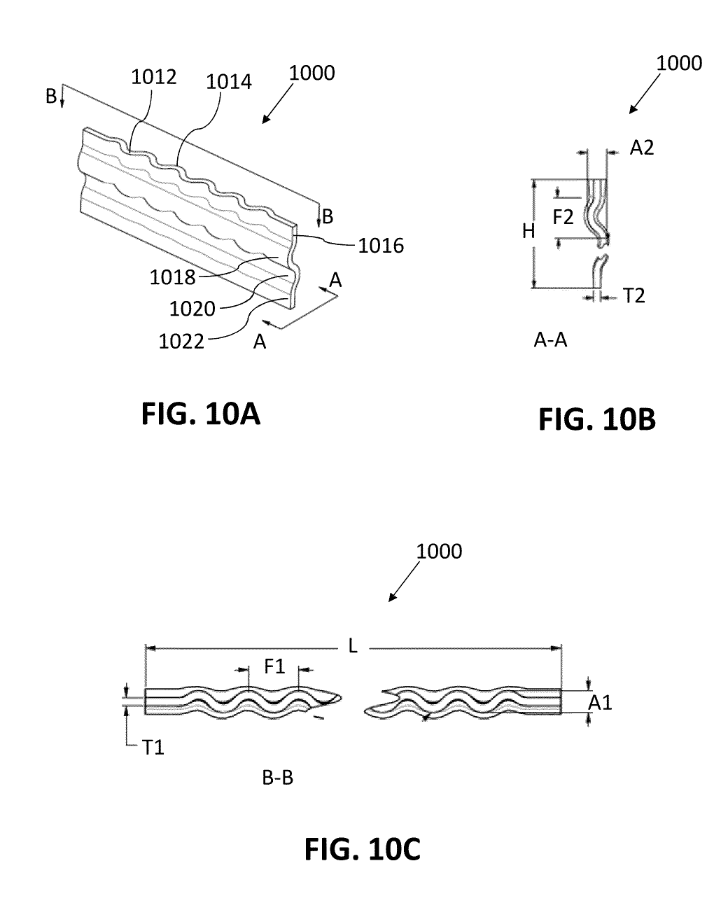

FIG. 10A illustrates a perspective view of an example embodiment of a tire sipe blade 1000. Tire sipe blade 1000 may be used in forming a sipe featuring an S-shaped geometry. A tire formed using tire sipe blade 1000 may have sipe dimensions substantially similar to those described below with respect to tire sipe blade 1000.

As illustrated, tire sipe blade 1000 may comprise an S-shaped geometry in planes corresponding to each of an XY-plane, an XZ-plane, and a YZ-plane. In another embodiment, tire sipe blade 1000 may comprise an S-shaped geometry in at least one of an XY-plane, an XZ-plane, and a YZ-plane. In another embodiment, tire sipe blade 1000 may comprise an S-shaped geometry in at least two of an XY-plane, an XZ-plane, and a YZ-plane. In one embodiment, tire sipe blade 1000 may comprise a curve having an amplitude that varies along the height of sipe blade 1000 in a YZ-plane. In one embodiment, tire sipe blade 1000 may comprise a curve having an amplitude that decreases along the height of sipe blade 1000 in a YZ-plane.

Tire sipe blade 1000 may comprise at least one convex portion 1012, at least one concave portion 1014, an upper vertical section 1016, a first curvilinear portion 1018, a second curvilinear portion 1020, and a lower vertical section 1022.

FIG. 10B illustrates a side elevational view of an example embodiment of a tire sipe blade 1000 taken about a view A-A.

Tire sipe blade 1000 may include S-shaped geometry having an amplitude A2. Amplitude A2 may be any of a variety of values. In one embodiment, amplitude A2 may range between about 0.25 mm and about 20.0 mm. In another embodiment, amplitude A2 may be greater than about 20.0 mm. In another embodiment, amplitude A2 may be less than about 0.25 mm.

Tire sipe blade 1000 may include S-shaped geometry having a wavelength F2. Wavelength F2 may be any of a variety of values. In one embodiment, wavelength F2 may range between about 1.00 mm and about 85.0 mm. In another embodiment, wavelength F2 may be greater than about 85.0 mm. In another embodiment, wavelength F2 may be less than about 1.00 mm.

Tire sipe blade 1000 may comprise a thickness T2. Thickness T2 may be any of a variety of values. In one embodiment, thickness T2 may range between about 0.25 mm and about 10.0 mm. In another embodiment, thickness T2 may be greater than about 10.0 mm. In another embodiment, thickness T2 may be less than about 0.25 mm.

Tire sipe blade 1000 may comprise a height H. Height H may be any of a variety of values. In one embodiment, height H may range between about 3.00 mm and about 275.0 mm. In another embodiment, height H may be greater than about 275.0 mm. In another embodiment, height H may be less than about 3.00 mm.

FIG. 10C illustrates a top elevational view of an example embodiment of a tire sipe blade 1000 taken about a view B-B.

Tire sipe blade 1000 may include S-shaped geometry having an amplitude A1. Amplitude A1 may be any of a variety of values. In one embodiment, amplitude A1 may range between about 0.25 mm and about 20.0 mm. In another embodiment, amplitude A1 may be greater than about 20.0 mm. In another embodiment, amplitude A1 may be less than about 0.25 mm.

Tire sipe blade 1000 may include S-shaped geometry having a wavelength F1. Wavelength F1 may be any of a variety of values. In one embodiment, wavelength F1 may range between about 1.00 mm and about 85.0 mm. In another embodiment, wavelength F1 may be greater than about 85.0 mm. In another embodiment, wavelength F1 may be less than about 1.00 mm.

Tire sipe blade 1000 may comprise a thickness T1. Thickness T1 may be any of a variety of values. In one embodiment, thickness T1 may range between about 0.25 mm and about 10.0 mm. In another embodiment, thickness T1 may be greater than about 10.0 mm. In another embodiment, thickness T1 may be less than about 0.25 mm.

Tire sipe blade 1000 may comprise a length L. Length L may be any of a variety of values. In one embodiment, length L may range between about 2.00 mm and about 900.0 mm. In another embodiment, length L may be greater than about 900.0 mm. In another embodiment, length L may be less than about 2.00 mm.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11. Cartesian coordinates referenced herein are intended to comply with the SAE tire coordinate system.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A tire, comprising:
a tread portion comprising at least one of a tread block and a tread rib;
at least one of the tread block and the tread rib having at least one sipe,
wherein the at least one sipe includes at least one convex portion and at least one concave portion forming an S-shaped geometry in a ground-contacting surface,
wherein the at least one sipe includes an upper vertical section and a lower vertical section oriented substantially radially within the sipe,
wherein the at least one sipe includes a first curvilinear portion and a second curvilinear portion oriented substantially radially within the sipe, and forming an S-shaped geometry having an amplitude, and
wherein the at least one sipe has a height.

2. The tire of claim 1, wherein the amplitude is substantially constant along the height of the sipe.

3. The tire of claim 1, wherein the amplitude varies along the height of the sipe.

4. The tire of claim 3, wherein the amplitude is reduced as the S-shaped geometry extends from a radially outermost portion to a radially innermost portion.

5. The tire of claim 1, wherein the upper vertical section is in communication with the ground-contacting surface.

6. The tire of claim 1, wherein the sipe is oriented substantially axially relative to the tire tread.

7. The tire of claim 1, wherein the at least one sipe increases a stiffness of at least one of the tread block and the tread rib.

8. The tire of claim 1, wherein the at least one sipe reduces irregular wear of at least one of the tread block and the tread rib.

9. The tire of claim 1, wherein the S-shaped geometry reduces the occurrence of stones or other debris from entering the sipe.

10. A tire, comprising:
a tread portion comprising at least one of a tread block and a tread rib;
at least one of the tread block and the tread rib having at least one sipe,
wherein the at least one sipe includes at least one convex portion and at least one concave portion forming an S-shaped geometry in a ground-contacting surface,
wherein the at least one sipe includes an upper vertical section and a lower vertical section oriented substantially radially within the sipe,
wherein the at least one sipe includes a first curvilinear portion and a second curvilinear portion oriented substantially radially within the sipe, and forming an S-shaped geometry having an amplitude, and
wherein the amplitude varies along a height of the sipe.

11. The tire of claim 10, wherein the amplitude is reduced as the S-shaped geometry extends from a radially outermost portion to a radially innermost portion.

12. The tire of claim 10, wherein the upper vertical section is in communication with the ground-contacting surface.

13. The tire of claim 10, wherein the sipe is oriented substantially axially relative to the tire tread.

14. The tire of claim 10, wherein the at least one sipe increases a stiffness of at least one of the tread block and the tread rib.

15. The tire of claim 10, wherein the at least one sipe reduces irregular wear of at least one of the tread block and the tread rib.

16. The tire of claim 10, wherein the S-shaped geometry reduces the occurrence of stones or other debris from entering the sipe.

17. A tire sipe blade, comprising:
at least one convex portion and at least one concave portion forming an S-shaped geometry;
at least one upper vertical section and at least one lower vertical section substantially parallel to one another;
a first curvilinear portion and a second curvilinear portion forming an S-shaped geometry having an amplitude; and
wherein the tire sipe blade has a height.

18. The tire sipe blade of claim 17, wherein the amplitude is substantially constant along the height of the tire sipe blade.

19. The tire sipe blade of claim 17, wherein the amplitude varies along the height of the tire sipe blade.

20. The tire sipe blade of claim 19, wherein the amplitude is reduced as the S-shaped geometry extends from a radially outermost portion to a radially innermost portion of the tire sipe blade.
